(19) United States
(12) Patent Application Publication
(10) Pub. No.: US 2002/0016764 A1
(43) Pub. Date: Feb. 7, 2002

(54) Internet expense account

(76) Inventor: Roger P. Hoffman, Green Bay, WI (US)

Correspondence Address: WEISS & WEISS, Suite 305, 500 Old Country Road, Garden City, NY, 11530, US

(21) Appl. No.: 09/898,098

(22) Filed: Jul. 3, 2001

Related U.S. Application Data
(63) Continuation-in-part of application No. 09/609,801, filed on Jul. 3, 2000.

(51) Int. Cl. G06F 17/60

(52) U.S. Cl. 705/39

(57) ABSTRACT

The present invention relates to a method and system for putting a person's expenses onto an Internet Expense Account.

### RELATED APPLICATIONS

This application is a continuation-in-part of Ser. No. 09/609,801, filed on Jul. 3, 2000, now pending.

### FIELD OF THE INVENTION

The present invention relates to a method and system for putting a person's expenses onto an Internet Expense Account.

### BACKGROUND OF THE INVENTION

Individuals who need to track expenses they incur while traveling are forced to retain and carry paper receipts. These receipts include hotel, restaurant, rental car, and airfare receipts. These receipts are often cumbersome, easily lost or misplaced. A business traveler may accumulate a substantial number of these receipts over the course of a trip and be faced with the time-consuming task of organizing, categorizing, and transcribing the dollar amounts to enable one to complete an expense report. Significant costs are associated with reconciling expense reports with paper receipts, the business must bear the overhead of their employee's time being spent obtaining a receipt, interpreting and transcribing the information contained in the receipt.

Many people who travel do not ultimately pay for their travel related expenses. For example, they are often paid by the person's employer, or a sponsoring organization. In order for these travelers to be reimbursed for all of their expenses, they are required to obtain and keep paper receipts, which must be submitted, to the ultimate payer. If a traveler lost, or, did not obtain a paper receipt for a particular expense, the payer would not reimburse for the expense.

In addition to submitting receipts, a traveler is often required to fill out a detailed expense report. Before reimbursement, the ultimate payer would review the receipts and detailed expense report to ensure all expenses were legitimate or fell within proper guidelines. The ultimate payer is then required to maintain a record of receipts for tax purposes.

Usually such expense reports are keyed into a computer by employee receivable staff, for entry into a travel management system. With this method of handling an expense account, considerable time passes before the employee receives reimbursement. Where an employee has incurred expenses on behalf of the company on a credit card, the employee is required to make a payment to the credit card issuer before a pre-determined date. The employee may not receive reimbursement before the pre-determined date. Often reports and receipts are stored in storage boxes, although some are microfilmed.

U.S. Pat. No. 5,899,981 relates to a system method for processing expense reimbursement claims supported by at least one receipt associated with identifying indicia. The system includes computer readable memory, in which is defined an expense voucher record having a charge field for identifying an entry incurring expenses, an expense field for identifying expenses incurred by the entity, and a voucher identification field.

U.S. Pat. No. 6,009,408 relates to a system for facilitating the processing of travel related expenses which includes a database which stores a traveler profile, a customer profile, and a traveler category rule set. A controller connected to the database, receives travel itinerary information for a traveler associated with a customer. The controller determines a specified amount of funds to be allocated to the traveler and transfers the specified amount of funds from an account of the customer. The controller provides at least a portion of the transferred funds to the traveler. The controller receives a record of any transactions in which the traveler spends the portion of transferred funds, thereby facilitating the processing of travel related expenses.

U.S. Pat. No. 5,379,512 relates to a system for digital delivery of receipts. Digital receipts can be delivered over a proprietary or over an open network such as the Internet. It can be uploaded to a smart card. It can be standardized in format to facilitate automated processing. An e-mail address can be incorporated into a bank card or other machine readable and for automatic routing of the receipt to a payor's e-mailbox. This invention does not organize the receipts in any way.

Although a receipt is sent to a person's e-mail address, it does not organize these receipts. So that rather than a businessman carrying around paper receipts the person now has to print out the e-mails and turn them into an accounting department or provide information about the receipts on a separate expense account form. Information regarding, the number of persons who attended the meal, the client who should be billed for this expense, or any organized format which could be used for submission to a business or for tax purposes is not provided.

### SUMMARY OF THE INVENTION

The present invention relates to a system and method for putting a person's expenses onto an Internet Expense Account.

The present invention relates to a method for delivering expenses into an Internet expense account. It is an object of the present invention to allow a user to swipe a card having a person's email address encoded on the card through a card reader. Information about the expense is entered into the card reader. The information is then sent via email into a text document that has fields for the information that is entered regarding the expense.

It is an object of the present invention for the information regarding expenses to be first sent to the credit card company and then the information transmitted to the system of the present invention. It is an object of the present invention for information from multiple credit cards to be organized in a single or multiple expense reports.

It is a further object of the invention wherein further information is entered into the Internet expense account other than information from a credit card. It is an object of the invention to provide this further information via wireless means such as through cellular phone, pager or via email. It is a further object of the invention to provide an Internet expense account where the information from the card cannot be deleted in the text document.

The present invention relates to a system for generating an Internet Expense Account comprising: a card having a person's email address and a text document made up of fields. The text document is part of an email server. The system of the present invention allows information to be transferred from a credit card, debit card or other type of card to the text document. It is an object of the present invention for the information to be sent or transferred from another source such as a computer system of a credit card company or an individuals computer system. It is a further object of the present invention to provide a system wherein the fields of the text document include expenses, date, and name of party to whom payment is due. It is a further object of the present invention to provide a system wherein the fields further comprise to whom the expenses are billable. It is a further object of the present invention to provide a system wherein the system allows further information to be inputted into the text document. It is an object of the present invention to input the further information via wireless methods, such as, cellular phone, pager or e-mail. It is an object of the system of the present invention wherein the information from the card cannot be changed in the text document. The system of the present invention further comprises a system wherein the fields include travel, food and accommodations.

In one embodiment, a person when paying a bill uses a card, which has an electronic mail address, encoded on a magnetic strip or by a chip. When the card is swiped the billing information is automatically sent to the email address encoded on the magnetic strip or by a chip. The system of the present invention provides an e-mail address for each individual's card so all billing information sent by this card is placed in the same file.

It is an object of the invention for the system of the present invention to create an online expense account. It is an object of the present invention to provide in one document for which all of the bills from a single card can be entered. It is an object of the present invention to provide in one document for which all of the bills from multiple cards of user can be entered. It is a further object of the present invention to list bills by date. It is a further object of the invention to place each of the expenses into separate fields, into transportation; airfare, car rental, etc.; food, i.e. restaurants; accommodations i.e. hotel.

It is an object of the present invention to allow a user to input data in separate fields along side the information provided by the swiped card, such as number of persons who are included in the bill, who this charge is billable to and additional expenses that were paid for in cash, such as tips. It is an object of the present invention not to allow a user to change any of the information which was transferred from the swiped card and entered into the Internet expense account.

It is an object of the present invention to allow a user to input data into the Expense Account which is transferred by wireless method and is not associated with a card. Such expenses include Taxi, tips, and other expenses which are not associated with a credit card.

It is an object of the present invention to allow more than one electronic mail address to be encoded on a magnetic strip. In this way both the person who uses the card and other persons responsible for paying the bills can get a copy of the receipt.

The present invention can also work without a card, but solely through wireless means, such as cellular phone, pager or e-mail. A person can have all of their expenses placed into a single Internet Expense Account via wireless means.

It is an object of the present invention to convert different currencies into a single currency that is used by the user.

### DETAILED DESCRIPTION OF THE INVENTION

Expense of Internet Expense Account

| | | | # of | Client | Other | |
|---|---|---|---|---|---|---|
| Charges | Amount | Date | People | Billed | Expenses | |
| Food | | | | | | |
| Restaurant A | $100.00 | 4/11/00 | 2 | 35214.1 | Tip | $5.00 |
| Restaurant B | $200.00 | 4/12/00 | 2 | 35214.1 | | |
| Travel | | | | | | |
| Airline A | $700.00 | 4/11/00 | 2 | 35214.1 | | |
| Car Rental A | $400.00 | 4/11/00 | 2 | 35214.1 | | |
| Accommoda- | | | | | | |
| tions | | | | | | |
| Hotel A | $1000.00 | 4/12/00 | 2 | 35214.1 | Tips | $10.00 |

In a preferred embodiment, the information from the credit card is delivered to the expense account of a user. This information cannot be changed by the user. The system of the present invention analyzes the bill and places the correct information into the correct field. For example, as shown above the system can place the name of the restaurant in one field, the dollar amount in a separate field and the date of the expense in a third field. The user can then enter their Internet expense account and add additional information such as the number of persons (and the names of those persons) who are covered by this bill, the client who is being billed for this charge and any additional amounts that were paid for in cash, such as tips. Further information such as accommodations and travel arrangements can also be put into separate fields as shown above.

In a further embodiment, other expenses, which are not normally associated with a card, can also be inputted into the Internet Expense Account. When a user is in a taxi and receives a receipt, they can call into the Internet Expense Account of the present invention and input their expense and all related information as shown above. This can be done for example via sending an email to their Internet expense account or calling in from a pager or cellular phone.

In another embodiment, the present invention can be used to keep track of a personal expense account. In this way a credit card holder would not need to wait until the end of the month or the end of the credit card companies billing period to review their expenses. For instance the system of the present invention could keep track of the expenses of each cardholder within a family to determine the breakdown of the expenses per cardholder. The information within a personal credit card could then be broken down into shopping, i.e., clothing; food, i.e., restaurants; travel; and other fields for the different expenses which are billed on a credit card.

Another benefit of the present invention is to identify when a credit card has been used illegally, or by a person not authorized to use the credit card. Credit cards are stolen, and/or misbilled which causes the credit card company millions of dollars, and causes time and energy for the card holder to explain why the charges on the credit card are not theirs. Using the system of the present invention a cardholder knows immediately about the expenses that have been charged on their credit card and therefore can determine whether these charges are proper.

A credit card can have an electronic mail address encoded on the magnetic strip which would be used by a business to send the receipt electronically. Bankeards (e.g. credit or debit cards) are known in the art to be used for automated financial transactions. By using a digitally-encoded magnetic strip which contains the user's name and account number, the user is afforded access to computer networks by having the card read by a machine.

In one embodiment, the present invention handles purchase transactions, including a cash register and a card reader for reading cards which include at least one electronic mail address. When the cash register generates a receipt, a transmitter sends an electronic copy of the receipt to the electronic mail address. The electronic copy may be digitally signed by either the vendor, customer or both before sending it to the e-mail address. The electronic receipt may be sent to the customer as well as to whoever pays for the travelers expenses at the company.

In a further embodiment, a user can enter a transaction in a standard credit card model, wherein a user's credit card is swiped and the information is sent to the credit card company. The credit card company can then submit the information to the system of the present invention as described above, or can email the information to the user to be entered into the system of the present invention. The information from the credit card can then be broken up as shown in the Expense of Internet Expense Account shown above. Using this method, a user can submit multiple credit cards into the present invention and they can all be placed into a single Internet Expense Account.

In a preferred embodiment, the system of the present invention includes an alarm for an expense over a certain price. For instance for food, if the bill is for over $100 per person, then the expense can be sent directly to a certain user, such as the person who pays a company's bills. Different limits which set off the alarm can be set. There can be a limit for travel, accommodations, etc. This can also be used by a parent for their children or a spouse.

In a further embodiment, expenses in an Internet expense account can be compared to other prices on the Internet. For instance, if a user has been told that they are to get the cheapest flight, the expense entered into the system can be checked against airfares for the same day on the Internet to see if the cheapest fight was purchased. This is especially important if tickets or accommodations are purchased in advance, these purchases can be monitored by the system of the present invention.

The system of the present invention can be connected to a travel agency so that all purchases are sent to the system of the present invention.

In an embodiment of the present invention, the system has a correction table, if the user believes that any of the expenses are incorrect.

Below are lists of other expenses that can also be placed on the system of the present invention:

Home phone or portion thereof

Cars/lease payments

Gas cards

Country club expenses/Health Club

Medical expenses

Car allowance

Mileage reimbursement

Insurance

Mail/postage/facsimile

Parking

Calling cards can also be placed on the system of the present invention. Cellular phone expenses can also be submitted to the system of the present invention.

In an embodiment of the present invention, the Internet Expense Account can be organized by client. The client can then put up red flags if certain expenses exceed what is allowable. The client can set up the Internet Expense Account when the total charges exceed a certain amount or when certain classification of charges exceed a certain amount. The same rules can be employed by an employer of their employees.

In the claims

1. A method for placing expenses in an Internet expense account comprising;
transferring expense information from a users credit card into a users email address;
entering said information into fields of said Internet expense account.

2. The method of claim 1 wherein further information is entered into the Internet expense account other than said information from said card.

3. The method of claim 1 wherein information from said card cannot be deleted.

4. The method of claim 1 wherein said expense information is from multiple credit cards.

5. The method of claim 1 further comprising;
activating an alarm when an expense in said field is greater than a certain amount.

6. A system for generating an Internet Expense Account comprising:
a text document made up of fields;
said text document being part of an email server;
said system accepting information regarding expenses transferred into said text document.

7. The system of claim 6 wherein said fields include expenses, date, and name of party to whom payment is due.

8. The system of claim 6 wherein said fields further comprise to whom said expenses are billable.

9. The system of claim 6 wherein said system allows further information to be inputted into said text document.

10. The system of claim 6 wherein said system divides said information into separate fields.

11. The system of claim 10 wherein said fields include travel, food and accommodations.

12. The system of claim 9 wherein said further information is inputted by a wireless device.

13. The system of claim 6 further comprising;
an alarm when an expense in said field is greater than a certain amount.
